(19) United States
(12) Patent Application Publication
(10) Pub. No.: US 2008/0278741 A1
(43) Pub. Date: Nov. 13, 2008

(54) SCOPE-BASED XPS FILTER DRIVER CONFIGURATION TO PERFORM DYNAMIC OPERATIONS

(75) Inventor: Charles Thomas Armstrong, Irvine, CA (US)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/746,198

(22) Filed: May 9, 2007

(51) Int. Cl. G06F 3/12

(52) U.S. Cl. 358/1.15

(57) ABSTRACT

A filter pipeline framework is provided for a printer driver including a plurality of filters. The framework includes a logical page filter configured to perform operations on logical pages within a first thread; a document level filter configured to perform document level operations within a second thread; a job level and physical page filter configured perform job level operations and physical page operations within a third thread; and a command managing unit configured to generate and manage commands compiled in command lists for the filters. Print ticket processing is performed at the beginning of the filter pipeline in the logical page filter. And further, each filter simultaneously runs within its own thread to perform a specific scope of operations defined for each filter.

### CROSS REFERENCE TO RELATED APPLICATIONS

The present application is related to U.S. patent application Ser. No. 11/560,715, filed Nov. 16, 2006, entitled “Pseudo-Multithread Framework For XPSDrv Filter Pipeline, the content of which is expressly incorporated by reference herein in its entirety.

### BACKGROUND OF THE INVENTION

1. Field of the Invention

The present invention relates to an improvement to the Microsoft® Windows® family of operating systems, and in particular, to the addition of a pseudo-multithread framework to the filter pipeline of an XPSDrv print driver.

2. Description of the Related Art

Recently, Microsoft Corporation has introduced the Microsoft® Windows Vista™ operating system. One of the new features of this operating system is the XPS print path which includes a print architecture that is designed to improve support for printing and document processing.

In particular, print jobs that are processed through the XPS print path are processed by a print driver (referred to as the “XPSDrv” print driver) which includes a filter pipeline (referred to as the “XPSDrv Filter Pipeline”). The XPSDrv print driver and print path processing are described in greater detail in the Microsoft® Windows® whitepaper entitled “The XPSDrv Filter Pipeline”, published Nov. 3, 2005 (see http://wwww.microsoft.com/whdc/)

FIG. 1 illustrates system components of the conventional XPS print path which includes the XPSDrv print driver. The XPSDrv print driver further includes the XPSDrv Filter Pipeline which is considered the main processing feature of the XPSDrv print driver. Here, the system components include a print subsystem module 100 which includes a scheduler 116, a port 118 and serialization services 120. Also, a print filter pipeline service module 102 is provided which includes a filter pipeline manager 122, an inter-filter communicator 124, and a series of filters 126, 128, 130 (e.g., Filters 1-n). In addition, the XPS print path utilizes a filter configuration file 106, an XPS spool file 108 and a printer 110 or the like.

The creation of a typical XPSDrv filter pipeline will now herein be described in greater detail. A print job 104 is received into the print subsystem module 100 where the print job 104 is spooled by a print spooler and a spool file for the job is created in the XPS spool file 108. After documents have been spooled into an XPS spool file 108 and the job is ready to print, the scheduler 116 signals the filter pipeline manager 122 to begin processing. The filter pipeline manager 122 then reads the filter configuration file 106 and loads the filters that are listed in the configuration file 106. Next, the filter pipeline is initialized.

Thereafter, the filter pipeline manager 122 begins the filter pipeline process wherein the first filter 126 (Filter 1) in the filter pipeline reads the contents of the XPS spool file 108 for the specific job. Here, the first filter 126 reads the document parts and XML PrintTickets (print ticket), and performs processing to the document. Then, the filter 126 sends the processed document parts to the next filter 128 in the pipeline (Filter 2). This process is facilitated by using the interfilter communicator (IFC) 124, which retains intermediate processing results until the next filter in the pipeline is available.

When the next filter 128 in the pipeline is ready, it reads the document parts that the previous filter 126 processed. After the data is processed, the results are written back to the interfilter communicator 124. This process is performed for each filter (1-n) in the filter pipeline. After each filter processing is complete, the output from the last filter 130 (Filter n) is sent to the port 118 defined by the printer driver such that a document may be printed via the printer 110, or the like.

As discussed above, the XPS spool file 108 for the job is fed to the filters (1-n). It is noted that the XPS spool file 108 is defined by a hierarchical set of document parts that describe different aspects of the content of the document. In particular, the XPS spool file typically includes a Fixed Document Sequence object, Fixed Document objects, and Fixed Page objects.

FIG. 2 is provided to illustrate the typical relation between a Fixed Document Sequence 140 object, Fixed Document 150 objects, and Fixed Page 160 objects. An XPS spool file 108 contains only one Fixed Document Sequence 140. The Fixed Document Sequence 140 contains one or more Fixed Documents 150 and may or may not contain a print ticket 142, which specifies the print settings for a print job, Fixed Document 150 or a Fixed Page 160. Further, a Fixed Document 150 contains one or more Fixed Pages and may or may not contain a print ticket. And also, a Fixed Page 160 contains resources (e.g., fonts 162, images 164) and may or may not contain a print ticket 146.

Although the overall performance of the XPSDrv print drivers for the Microsoft® Windows® family of operating systems provides a viable new print architecture that improves support for printers and document processing, it is noted, however, that there is an inherent processing restriction indigenous to the XPSDrv Filter Pipeline environment.

In particular, the filters in the pipeline 126, 128, 130 (1-n) are not recommended to spawn threads, meaning that, within a filter all processing has to performed in a sequential (single threaded) mode. As a result, since the filtering is performed sequentially, the overall processing time for the print job inherently has some undesired latency. That is to say, the filters in the pipeline 126, 128, 130 (1-n), and their order of execution, are statically defined by the XPSDrv print driver's filter configuration file 106, meaning that, filters in the pipeline and their order of execution cannot be dynamically changed based on the print ticket settings. As a result, the XPSDrv print driver's document processing can not be optimized for the print job and processing time for print jobs is increased.

To overcome the aforementioned drawbacks inherent in the current version of Microsoft's XPSDrv Filter Pipeline, an enhancement to the same has been proposed in related U.S. patent application Ser. No. 11/560,715, filed Nov. 16, 2006, entitled “Pseudo-Multithread Framework For XPSDrv Filter Pipeline.

The aforementioned approach provides the addition of a pseudo-multithread architecture/framework for the XPSDrv Filter Pipeline. This infrastructure allows Feature Commands to be executed in “parallel”, without the need to spawn threads. This approach is taken since it is not recommended to spawn threads in the current XPSDrv Filter Pipeline environment). Each Feature Command is given an opportunity to produce one (or more) page(s) before relinquishing the execution to the another Feature Command in the chain. Utilizing this principle, a Dynamic Feature Command Filter executing in the XPSDrv Filter Pipeline is able to produce output pages while the input pages are still being read.

Although the pseudo-multithread framework is certainly a viable approach, one drawback of this solution is that the pseudo-multithread framework implements all the specified operations in a single filter running in one thread. A disadvantage of such an approach is that the pseudo-multithreaded framework configuration mimicking multithreaded operations running in a single thread adds more complexity, and it involves redundant operations, such as an additional task for managing the Feature Command List for maintaining correct processing order.

Therefore, it would be advantageous to enhance the XPSDrv print driver for the Microsoft® Windows Vista™ operating system by adding and/or modifying software features which will help speed up the overall processing time for the print job even though filtering is performed sequentially.

### SUMMARY OF THE INVENTION

According to an exemplary embodiment of the present invention, a filter pipeline configuration (or framework) is provided as an improvement to the XPSDrv print driver utilized within the Microsoft® Windows® family of operating systems, such as the recently introduced Microsoft® Windows Vista™ operating system.

According to the present invention, filters are arranged in a specific order and tasks are distributed to three different filters running in a separate thread to perform specific scope of operations. Furthermore, operations performed in the filter can be dynamically configured based on the user print intent specified in the print ticket settings.

In particular, the filter pipeline configuration is provided to perform a dynamic set of operations from all the three filters based, and dynamically configured, on the users printing intent. As a result, this configuration allows three filters to run, each in a separate thread, simultaneously processing parts of the document without waiting for a previous filter to complete. That is to say, filters are not assigned based on the printing feature, rather, a filter is assigned based on the scope of operations.

As discussed in the Background Section, with regard to the conventional XPSDrv Filter Pipeline (see FIG. 1), each filter 1-n (reference numbers 126, 128, 130) is assigned to perform a single operation such as Watermark, N-up, color management, etc. With the conventional approach, the order of operation is fixed. Therefore, the order cannot be changed during the runtime. For example, if the configuration is Watermark and N-up, it is not possible to change the order for performing N-up and watermark on the physical page.

According to the present invention, filters are arranged such a way that operations on least dependent parts are performed first so that next filter can start processing parts of the document without any delay. The configuration allows the print ticket processing to be done at the very beginning of the pipeline in a Logical Page Filter (LPF) which improves the performance of the filter processing because document processing commands will be readily available for remaining filters to process the document without any delay.

According to another aspect of the present invention, a method is provided for configuring the XPSDrv Filter Pipeline based on the scope of the operations, wherein whole document processing is divided based on the scope of the operations, and these operations are performed in each filter simultaneously. I.E., the filters are performed one after another, wherein the first filter gets an opportunity to perform first, then second filter, and so on, etc.

Instead of processing specified operations in a single filter thread, there are three filters running in each thread performing assigned scope based operations which improves the performance of the print job. As a result, this method provides the arrangement of an XPSDrv Filter Pipeline in which the Logical Page Filter performs operations on the least single unit (or part) or least dependent unit (or part) of the document called logical page. Once the required processing on the part is complete, the same processed part will be sent to a Document Level Filter to be further processed further. As soon as the Document Level Filter gets the parts of the job, it starts processing the job.

According to another aspect of the present invention, the method includes processing all the print tickets of a print job from the Logical Page Filter which creates a Command Manager instance which parses the resultant job print ticket from merging of a default print ticket with the job print ticket and generates a Job Level Command List and Physical Page Command List. And upon parsing a resultant document print ticket from merging of resultant job and document print ticket, a Document Level Command List is generated. Also in a similar way, by parsing a resultant page print ticket from the merging of resultant document print ticket with page print ticket, a Logical Page Level Command List is generated. As soon as the resultant page print ticket is parsed, the Logical Page Filter gets the Logical Page Level Command List from the Command Manager and executes commands on this page. Once all the commands are executed, the Logical Page Filter sends out the page to the Document Level Filter.

Another aspect of the present invention is that the same Command Manager instance, created at the time of initialization of the Logical Page Filter, is passed to the Document Level Filter and the Job Level & Physical Page Filter through a property bag. When the Document Level Filter (DLF) gets the first document, the Document Level Command List, which is a list of commands to be performed on the document is available from the Command Manager. The Document Level Filter gets the Document Level Command List from Command Manager using part names and executes the same list on cached parts for each instance. I.E., the Document Level Filter gets a new Fixed Page part until it receives a new Fixed Document part.

And, according to yet another aspect of the present invention, upon receiving a Fixed Document Sequence part, the Job Level Filter calls the Command Manager to get a Job Level Command List and Physical Page Command List. On receiving every fixed page part, the Job & Physical Level Filter caches the incoming Fixed Page and executes all the job commands on cached pages. Moreover, while executing the job commands, if the command meets the condition, i.e., ready to process a Physical Page Command List, the command calls the Job Level & Physical Page Filter to execute the Physical Page Command List on the Fixed Page and sends out the processed Fixed Page to the Inter-Filter Communicator. The aforementioned chain of operations takes place until all three filters receive the final part.

Moreover, another aspect of the present invention includes the definition of commands which include a “pre-condition”, “operation”, and “post-condition”. A pre-condition triggers whether a command can be performed or not. A post-condition triggers performing an additional task after performing the command. For example, apart could be sent out to the next filter or additional physical commands are applied.

According to another aspect of the present invention, a filter pipeline framework is provided for a printer driver including a plurality of filters. The filter pipeline framework includes a logical page filter configured to perform operations on logical pages within a first thread; a document level filter configured to perform document level operations within a second thread; a job level and physical page filter configured perform job level operations and physical page operations within a third thread; and a command managing unit configured to generate and manage commands compiled in command lists for the filters. Here, print ticket processing is performed at the beginning of the filter pipeline in the logical page filter. And further, each filter simultaneously runs within its own thread to perform a specific scope of operations defined for each filter.

And, according to another aspect of the present invention, command lists are generated by the command manager via a request from the logical page filter. The command lists include a logical page command list for commands to be performed on individual logical pages; a document level command list for commands to be performed on fixed pages of an individual document; a job level command list for commands to be performed on a complete job; and a physical page command list for commands to be performed on individual physical pages.

Moreover, according to yet another aspect of the present invention, whole document processing is divided based on the specific scope of operations for each filter. Additionally, operations performed in each filter may be dynamically configured based on user intent specified in print ticket settings. Furthermore, the logical page filter, document level filter and job level and physical page filter are not assigned based solely on printing features.

Still yet, according to another aspect of the present invention, the logical page filter, document level filter and job level and physical page filter may be arranged such that operations on least dependent parts are performed first such that a next filter in the pipeline can start processing parts of a document without delay.

According to yet another aspect of the present invention, the filter pipeline includes a pre-condition command for triggering whether an operation on the command may be executed or not; and a post-condition command for triggering performing an additional task after performing a command.

According to still yet to another aspect of the present invention, the printer driver may be an XPSDrv print driver including an XPSDrv filter pipeline utilized within a Microsoft® Windows® operating system, wherein the Microsoft® Windows® operating system is one of Windows Vista™, Windows XP and Windows Server™ 2003.

Furthermore, according to yet another aspect of the present invention, a method for controlling a filter pipeline for a printer driver including a logical page filter, document level filter, job level and physical page filter, and command manager. The method includes processing print tickets in the logical page filter; then simultaneously, performing operations in the logical page filter on logical pages within a first thread, performing document level operations in the document level filter within a second thread, performing job level operations and physical page operations in the job level and physical page filter within a third thread; and generating and managing commands compiled in command lists for the filters, wherein each filter runs within its own thread to perform a specific scope of operations defined for each filter.

Additionally, according to yet another aspect of the present invention, a computer readable medium is provided containing computer-executable instructions for controlling a filter pipeline for a printer driver including a logical page filter, document level filter, job level and physical page filter, and command manager. Here, the medium includes computer-executable instructions for processing print tickets in the logical page filter; computer-executable instructions for then simultaneously, performing operations in the logical page filter on logical pages within a first thread, performing document level operations in the document level filter within a second thread, performing job level operations and physical page operations in the job level and physical page filter within a third thread; and computer-executable instructions for generating and managing commands compiled in command lists for the filters, wherein each filter runs within its own thread to perform a specific scope of operations defined for each filter.

Further embodiments, features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate various embodiments, features and aspects of the present invention and, together with the description, serve to explain the principles of the invention.

FIG. 1 illustrates the architecture of the conventional XPS print path which includes the XPSDrv print driver and XPSDrv filter pipeline.

FIG. 2 illustrates a conventional XPS spool file format.

FIG. 3 illustrates an overall Filter Pipeline Configuration, according to an aspect of the present invention.

FIGS. 4A illustrates an exemplary flow of an initialization procedure for the Logical Page Filter (LPF), according to an aspect of the present invention.

FIGS. 4B-E illustrate an exemplary flow of a start operation of the Logical Page Filter (LPF), according to an aspect of the present invention.

FIG. 5A illustrates an exemplary flow of an initialization procedure for the Document Level Filter (DLF), according to an aspect of the present invention.

FIGS. 5B-F illustrate an exemplary flow of a start operation of the Document Level Filter (DLF), according to an aspect of the present invention.

FIG. 6A illustrates an exemplary flow of an initialization procedure of the Job Level & Physical Page Filter (JL&PPF), according to an aspect of the present invention.

FIGS. 6A-G illustrate an exemplary flow of a start operation of the Job Level & Physical Page Filter (JL&PPF), according to an aspect of the present invention.

FIG. 7 illustrates an exemplary timing diagram of the overall functionality of the Logical Page Filter (LPF), Document Level Filter (DLF), and Job Level & Physical Page Filter (JL&PPF) according to an aspect of the present invention.

### DETAILED DESCRIPTION OF THE EMBODIMENTS

Exemplary embodiments, features and aspects of the present invention will now be herein described in detail below with reference to the drawings.

### First Exemplary Embodiment

The aforementioned features and aspects of the first exemplary embodiment will now herein be discussed in greater detail below.

### [Exemplary Filter Pipeline Configuration]

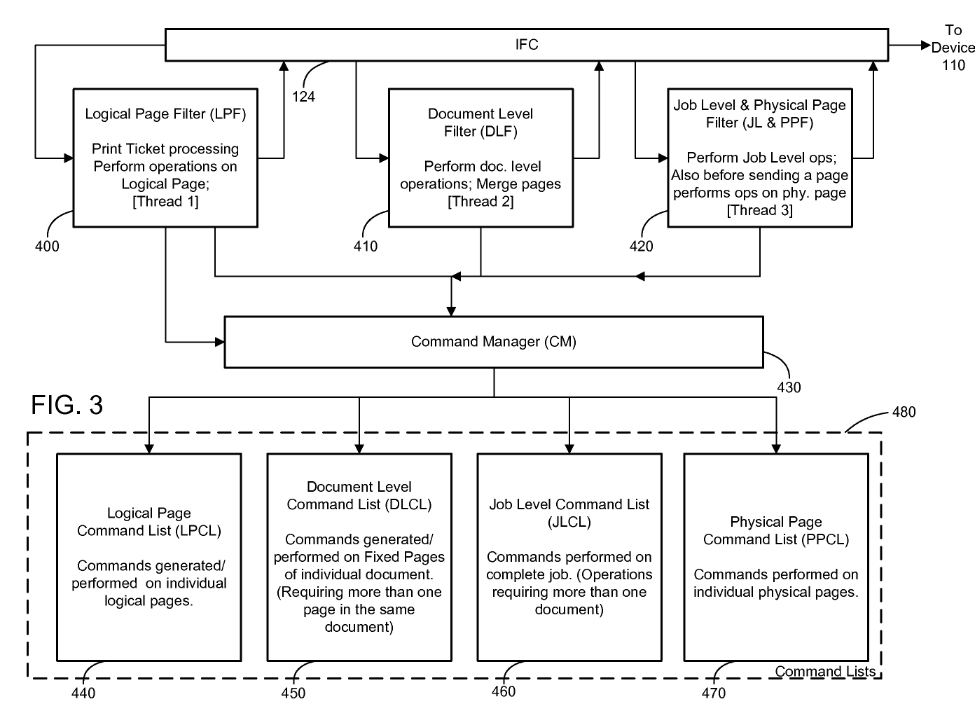

FIG. 3 illustrates an example overall filter pipeline configuration for a scope-based filter pipeline according to an aspect of a second exemplary embodiment of the present invention. The filter pipeline configuration includes a Logical Page Filter (LPF) 400, a Document Level Filter (DLF) 410, and a Job Level Filter (JLF) 420. Furthermore, the filter pipeline configurational so includes a Command Manager (CM) 430 which generates Command Lists 480 including a Logical Page Command List (LPCL) 440, Document Level Command List (DLCL) 450, Job Level Command List (JLCL) 460, and Physical Page Command List(PPCL) 470.

The Logical Page Filter 400 processes the Print Ticket and translates printing features into a list of scope based commands using an object created by a Command Manager (CM) 430. These commands will be performed on each filter. The Command Manager (CM) 430 parses the Print Ticket and generates a scope-based Command List 480 which includes a Logical Page Command List (LPCL) 440, a Document Level Command List (DLCL)450, a Job level Command List (JLCL) 460, and a Physical Page Command List(PPCL) 470.

In addition to parsing the Print Ticket using CM 430, the LPF 400 performs the generated command from the LPCL 440. When the LPF 400 receives a page part, it queries an object generated from the CM 430 object to get the logical page operations for the specific page and the LPF 400 executes these commands on the Fixed Page 160.

In particular, after receiving each part in the start operation, the LPF 400 checks the part type. If the part is a Fixed Document Sequence (FDS) 140, the LPF calls the CM 430 to process the part. Then the CM 430 gets the Print Ticket 142 for the FDS part and merges it with a default print ticket and saves the resulting print ticket (Resultant Job Print Ticket).

Next, the CM 430 parses the Resulting Job Print ticket to generate the Job Level Command List (JLCL) 460 and Physical Page Command List (PPCL) 470. If the part is Fixed Document (FD) 150 part, the LPF 400 calls CM 430 to process the FD 150. Next, the CM 430 gets the Print Ticket from FD 150 and merges it with a previously saved Resultant Job Print Ticket, in which the resulting Print Ticket is called a Resultant Document Print Ticket. Then the CM 430 parses the Resultant Document Print Ticket to generate the Document Level Command List (DLCL) 450.

Whenever the LPF 400 receives the Fixed Page (FP) 160, the LPF 400 calls the CM 430 to process the FP part. Here, the CM 430 gets the Print Ticket from FP and merges it with the previously saved Resultant Document Print Ticket, wherein the resulting print ticket is called a Resultant Page Print Ticket.

Then the CM 430 parses the Resultant Page Print Ticket to get a Logical Page Command List (LPCL) 440 for the page. Thereafter, the LPF 400 gets the LPCL 440 from the CM 430 and executes each command on the current Fixed Page (FP) 160 part. When all the commands are executed, the LPF 400 sends out the FP 160 to the Document Level Filter (DLF) 410, and further keeps processing until all the parts are processed.

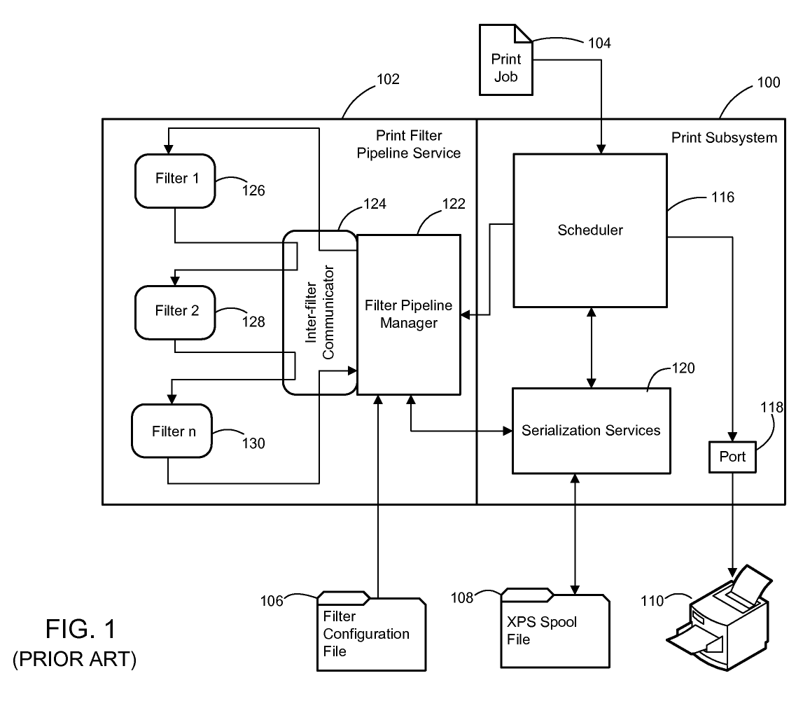

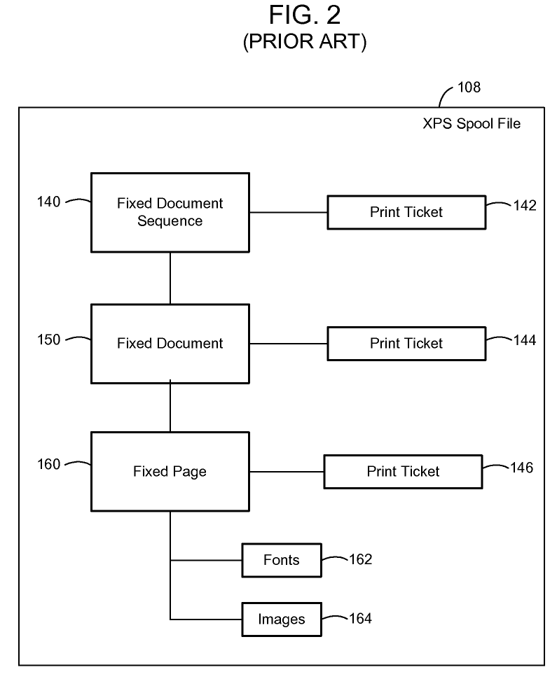

The Document Level Filter (DLF) 410 is configured to execute document-scope operations such as caching, moving, merging, inserting, deleting pages, etc. within the document. When the DLF 410 gets a Fixed Document 150 part, the DLF 410 queries the CM 430 for the Document Level Command List of (DLCL) to be performed on the subject Fixed Document 150 part. The CM 430 uses its part name and returns the Document Level Command List (DLCL) that will be performed on the subject document upon receiving each page part. It is noted that returning an empty list means that the DLF 410 will simply pass all the parts of the document to the next filter (Job level & Physical Page Filter) through the Inter-filter Communicator 124 (See FIG. 1).

The function of the Job Level & Physical Page Filter 420 (JL&PPF) is similar to the DLF 410, except the JL&PPF 420 performs operations across the document boundary. That is to say, Fixed Pages of the job level operations can belong to any document. For example, the JL&PPF 420 can move a page to a different document or merge pages from different documents, for instance.

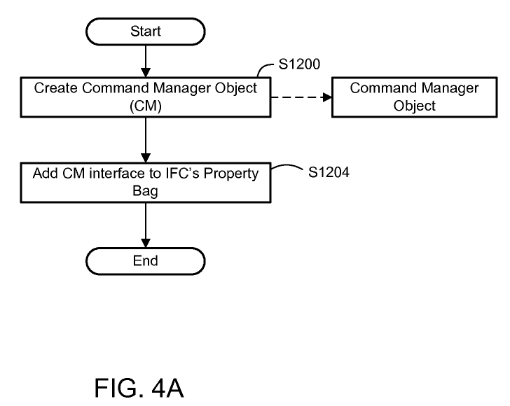

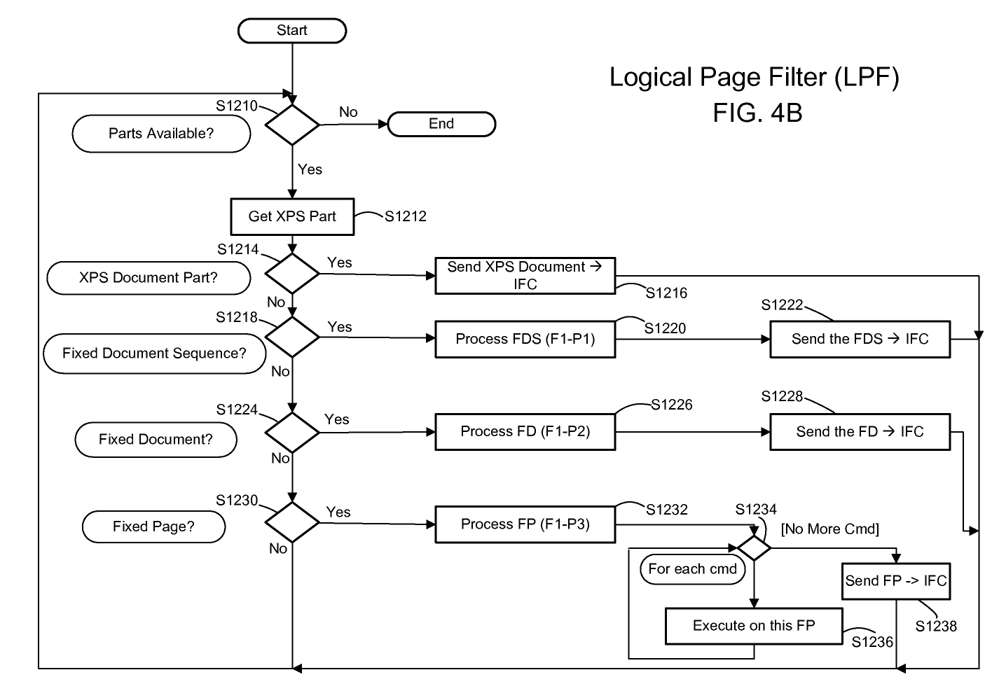

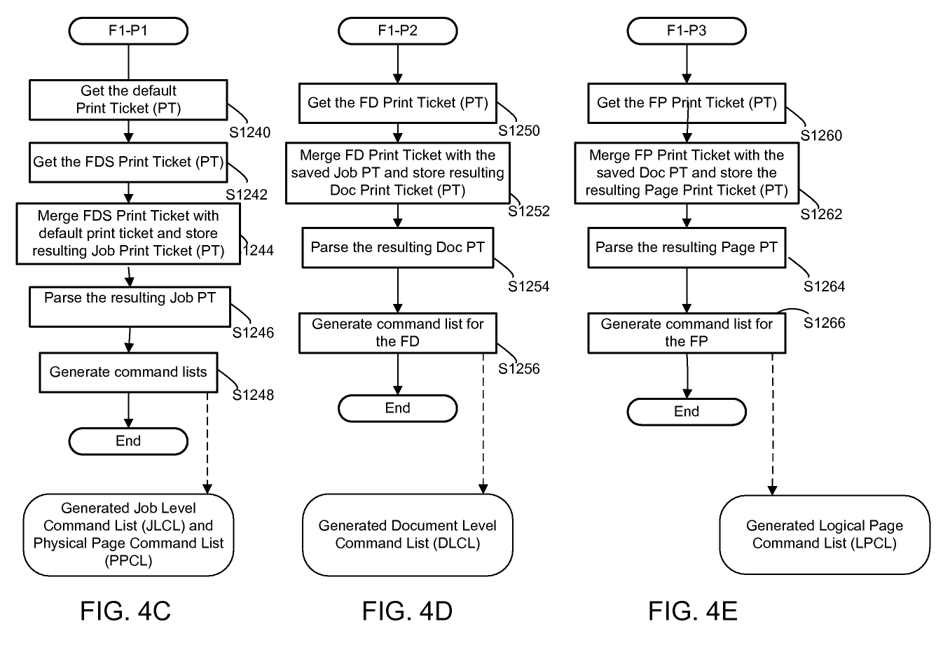

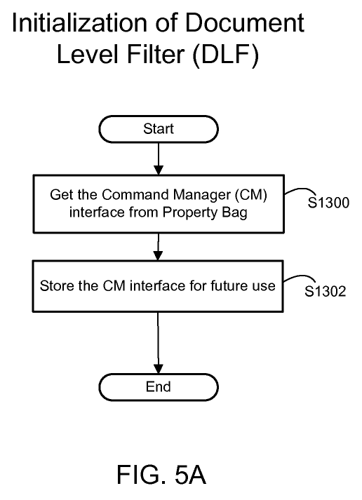

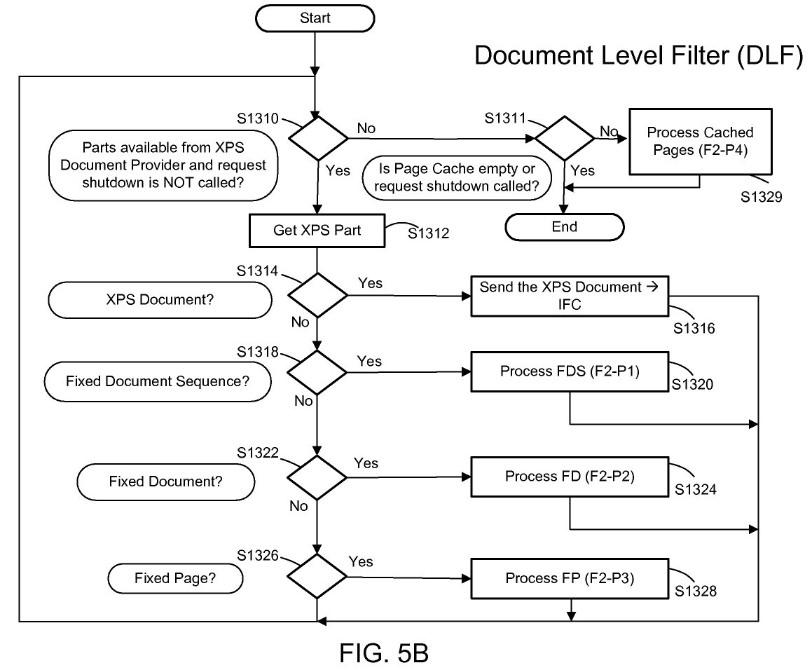

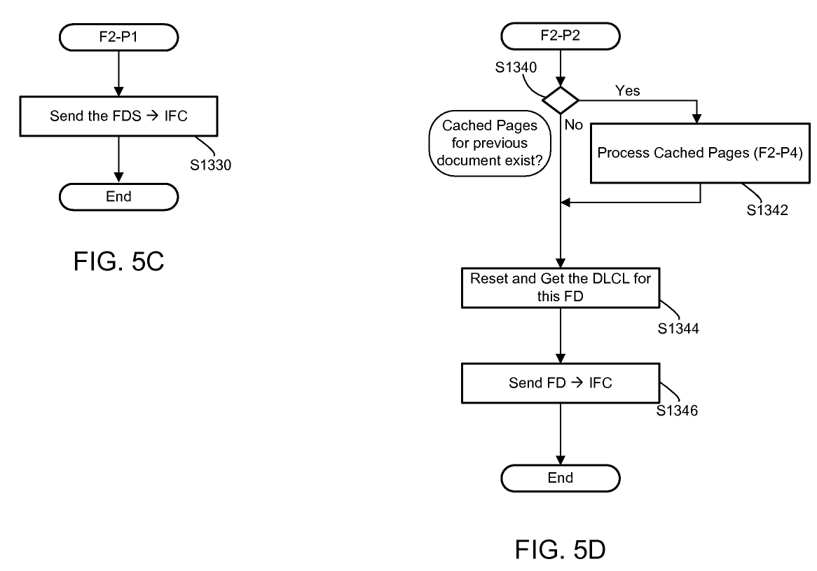

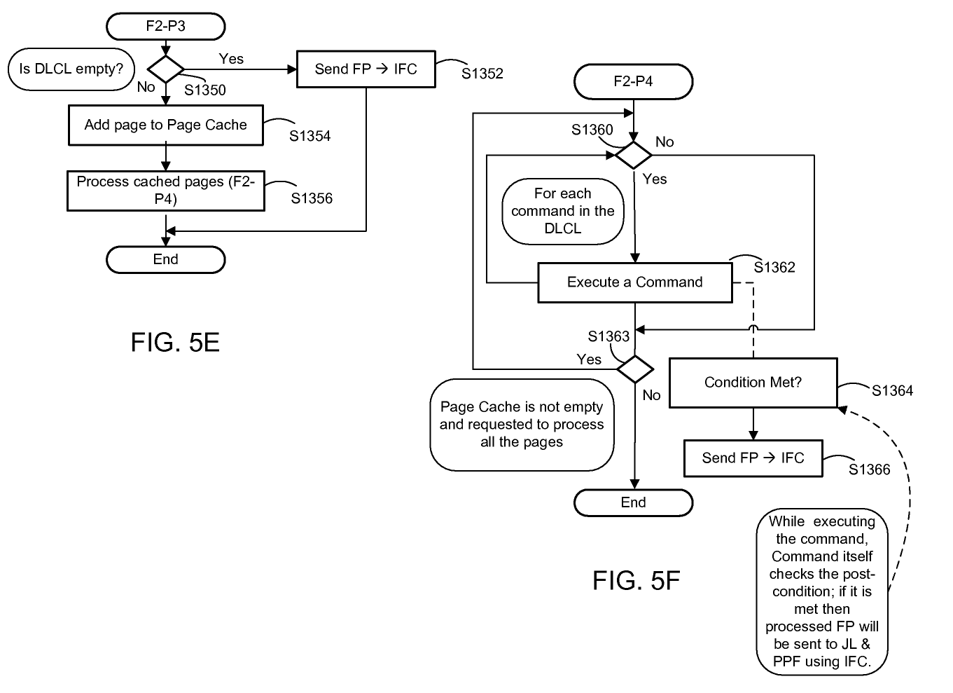

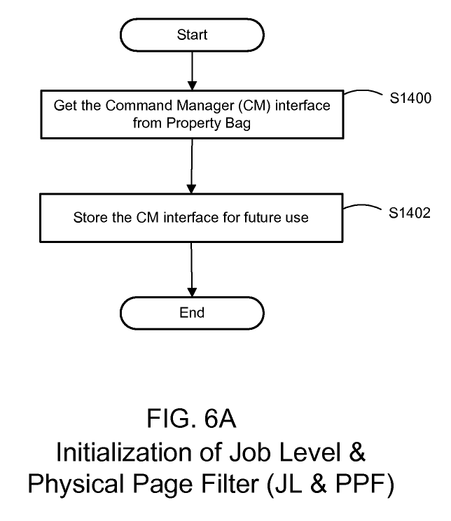

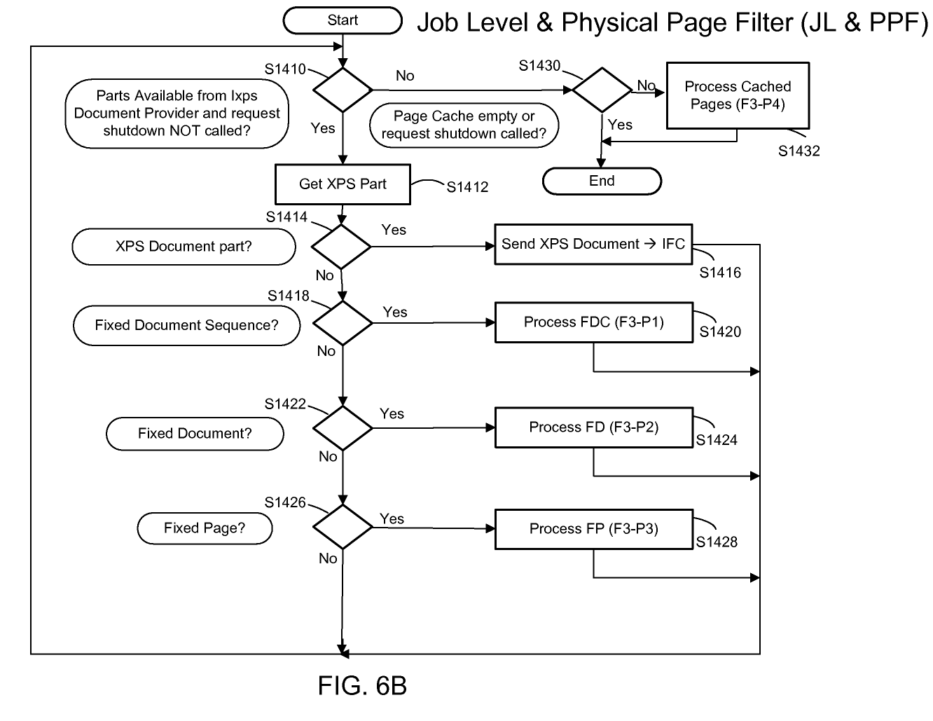

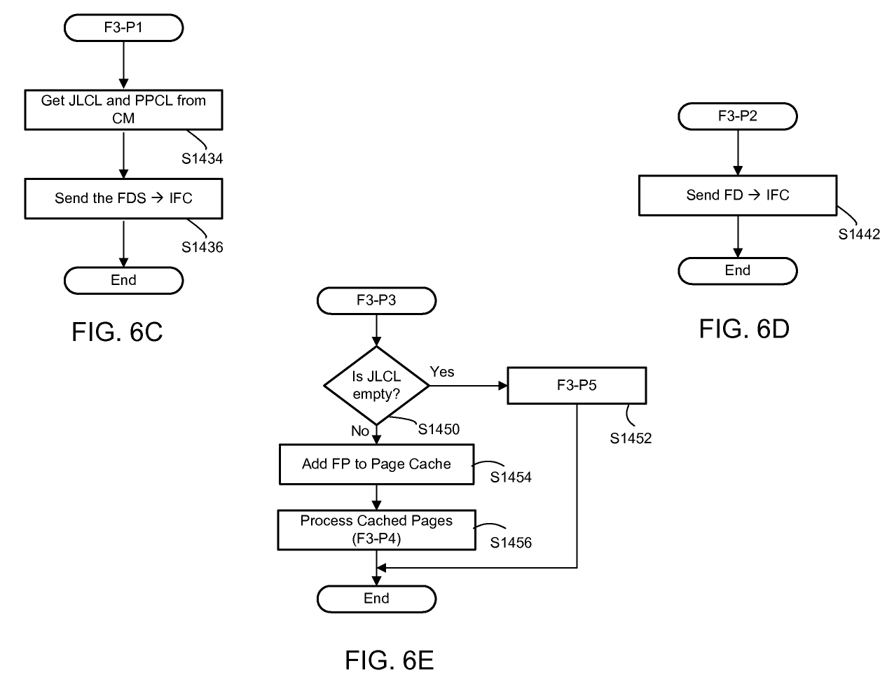

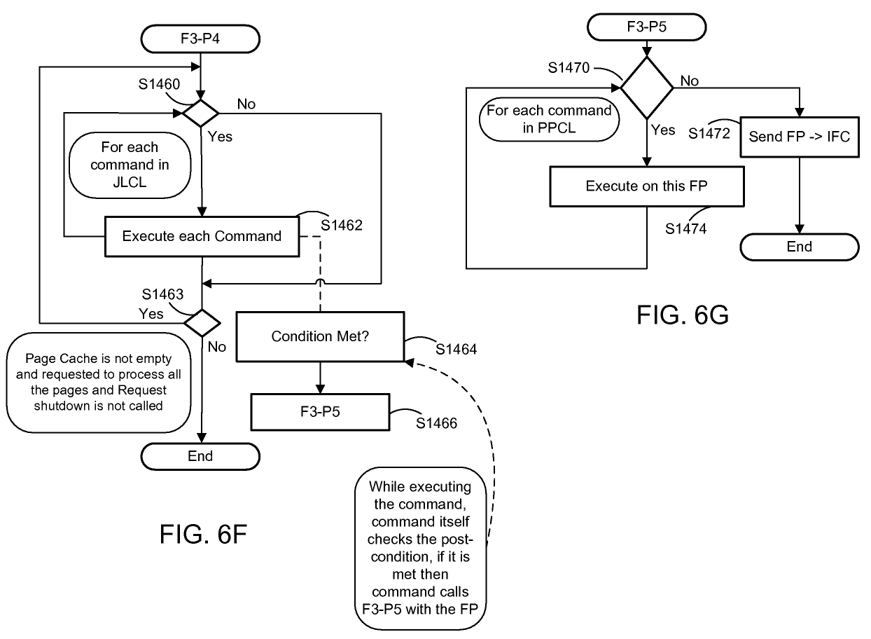

The aforementioned filters (LPF 400, DLF 410, and JL&PPF 420) are created and executed by the XPSDrv Filter Pipeline service when the Print Job 104 is spooled by the spooler. After the XPSDrv Filter Pipeline service creates filter objects, it initializes each filter by calling an initialization filter function. For example, in the initialization of the LPF 400 (as described in FIG. 4A later in the specification), a Command Manager 430 object is created and initialized. After initializing the CM 430 object, it is passed to other filters through a property bag item (as described in step S1204 in FIG. 4A later in the specification). In the initialization of the other filters (see FIGS. 5A, 6A later in the specification), the DLF 410 and JL&PPF 420, a CM 430 instance is retrieved from the property bag and stored for future use (as discussed later in steps S1300 and S1302 of FIG. 5A).

After initialization is done, the XPSDrv Filter Pipeline service calls for the start operation of each filter for the document processing as described in FIGS. 4B, 5B, 6B which are also described later in the specification.

### [Exemplary Initialization and Operation of Logical Page Filter]

FIGS. 4A-E illustrate an exemplary flow for the initialization and start operation of the Logical Page Filter(LPF) 400, according to an aspect of the present invention.

FIG. 4A illustrates an exemplary initialization of the LPF 400, wherein an object from the Command Manager 430 is created and initialized in step S1200. After initializing the CommandManager object, it is now able to be passed to the filters (LPF 400; LPF 410; JL&PPF 420) through a property bag from the Inter-Filter Communicator 124 in step S1204.

FIGS. 4B-E illustrate an exemplary flow of a start operation of the Logical Page Filter 400 (LPF), according to an aspect of the second embodiment of the present invention.

First, FIG. 4B illustrates an exemplary start operation of the Logical Page Filter (LPF) 400 where the LPF 400 sits in a loop getting parts from Microsoft's IXps Document Provider interface and performs processing on each part of the document until no more parts from the document provider are received or when shutdown is requested from the pipeline or other filters.

Referring to FIG. 4B, it is first determined whether or not there are any parts from Microsoft's IXps Document Provider interface in step S1210. If at step S1210 no parts are available, a CloseSender of Ixps Document Consumer is called and the current thread is ended.

If at step S1210 parts are available, the process moves to step S1212 where the XPS Document Parts are obtained from the IXps Document Provider interface. In step S1214, it is determined whether there is an XPS Document Part or not. If yes, then the XPS Document Part is sent to the IFC 124 at step S1216, and then the process returns to step S1210 to determine whether any more XPS parts are available. If there is no XPS Document Part in step S1214, then the process proceeds to step S1218.

Instep S1218, it is determined whether there is a Fixed Document Sequence (FDS) 140 or not. If yes, then the Fixed Document Sequence 140 is processed at step S1220 wherein the function F1-P1 is performed (see FIG. 4C; discussed later in specification). Then the Fixed Document Sequence 140 is sent to the IFC 124 (step S1222), and the process returns to step S1210. If there is noFixedDocument Sequence 140 in step S1218, then the process proceeds to step S1224.

In step S1224, it is determined whether there is a Fixed Document 150 or not. If yes, then the Fixed Document 150 is processed at step S1226 where the function F1-P2 is performed (see FIG. 4D; discussed later in the specification). Then the Fixed Document 150 is sent to the IFC 124 (step S1228), and then the process returns to step S1210. Further, if there is no Fixed Document 150 in step S1224, then the process proceeds to step S1230.

In step S1230, it is determined whether there is a Fixed Page 160 or not. If yes, then the Fixed Page 160 is processed at step S1232 where the function F1-P3 is performed (see FIG. 4E; discussed later in the specification). Next, also in step S1232 a Logical Page Command list (LPCL) 440 is returned to be applied to the Fixed Page 160.

Then the LPF 400 determines whether there are any pending commands to be processed (step S1234). If there are pending commands to be processed, then they are executed on the Fixed Page 160 (step S1236) until all the commands in the LPCL 440 are executed. When there are no more commands to be executed, the Fixed Page 160 is sent to the IFC 124 (step S1238), and the process returns to step S1210. Further, if there are no Fixed Pages 160 in step S1230, then the process returns to step S1210. [0071] Therefore, in review, when a part arrives at the LPF 400, first the type of the part is determined as specified in steps S1214, S1218, S1224 and S1230. If it is a XPS Document Part, in step S1214, the LPF 400 sends this part to the Document Level Filter 410 through IFC 124 as in S1216, or it comes to step S1218 where the LPF 400 checks for a Fixed Document Sequence 140 part, and if it is, then in step S1220, the LPF 400 calls the CM 430 to process the Print Ticket of this part. And similarly, in step S1224 it is determined if the part is a Fixed Document Part 150, and finally, in step S1230, it is determined if the part is a Fixed Page 160 or not.

### Exemplary Fixed Document Processing

FIG. 4C shows exemplary processing for the Fixed Document Sequence 140 Print Ticket 142 which is performed in function F1-P1 from step S1220 in FIG. 4B. Here, the Command Manager 430 gets the default Print Ticket 142 (step S1240) and Fixed Document Sequence 140 (FDS) Print Ticket (PT) 142 (step S1242). Then, the FDS PT and the default PT are merged and stored in a resulting Job Print Ticket (PT) (step 1244). Next, the resulting Job PT is parsed (step 1246) and the Job Level Command List (JLCL) 460 and Physical Page Command List(PPCL) 470 are generated (step S1248). As a result, a Resultant Job Print Ticket is then saved for future use.

After the Command Manager 430 finishes processing the Fixed Document Sequence 140, the LPF 400 sends out the Fixed Document Sequence 140 to the Document Level Filter 410 through the IFC 124 (step S1222). Then, if the part is a Fixed Document 150, the LPF 400 requests the CM 430 to perform the F1-P2 function as specified in step S1226, for instance.

FIG. 4D shows an exemplary processing for the Fixed Document (FD) 150 Print Ticket (PT) 144 which is performed in function F1-P2 from step S1226 in FIG. 4B. First, the Command Manager 430 gets the Fixed Document (FD) 150 Print Ticket (PT) 144 (step S1250). Then, the FD PT is merged with the saved Resultant Job Print Ticket and stored as a Resultant Document Print Ticket (step 1252). Next, the Resulting Document PT is parsed (step 1254) and a Document Level Command List (DLCL) is generated for the Fixed Document 150 (step S1256).

### Exemplary Fixed Page Processing

FIG. 4E shows exemplary processing of a Fixed Page (FP) 160 Print Ticket (PT) 146 by the Command Manager 430 which is performed in function (F1-P3) in step S1232 from FIG. 4B. In particular, if the part type is a Fixed Page 160 as determined in step S1230, the Logical Page Filter (LPF) 400 calls CM 430 to process the part using function (F1-P3) in step S1232.

Referring to FIG. 4E, first the CM 430 gets the Fixed Page (FP) 160 Print Ticket (PT) 146 (step S1260). Then, in step S1264, the FP PT is merged with the saved Resulting Document Print Ticket (see step S1252 in FIG. 4D). Next, a Resulting Page Print Ticket is parsed (step 1264) and a Logical Page Command List (LPCL) 440 is generated for the Fixed Page 160 (step S1266) and returned to the LPF 400.

Once the function (F1-P3) is complete, in step S1234, the LPF 400 executes each command in the LPCL 440 on the subject page. When all the commands are executed, the Fixed Page 160 will be sent to the Document Level Filter (DLF) 410 through the IFC 124 (step 1238).

### [Exemplary Initialization and Operation of Document Level Filter]

FIGS. 5A-F illustrate an exemplary flow for the initialization and start operation of the Document Filter 410, according to an aspect of the present invention.

FIG. 5A illustrates an exemplary initialization of the Document Level Filter DLF 410, wherein a Command Manager 430 interface is retrieved from the property bag (see step 1204 in FIG. 4A) and stored for future use. In particular, first the CM 430 interface is retrieved (step S1300) and then the CM 430 interface is stored for future use (step S1302).

FIG. 5B describes exemplary processing of the XPS Document in the start operation of Document Level Filter (DLF) 410 wherein each part is processed until no more parts are available from the Microsoft XPS Document provider interface or request shutdown is called (NO in step S1310).

Referring to FIG. 5B, first it is determined whether parts are available (step S1310). When a part is available (YES in step S1310), its type is determined (step S1312). In particular, if it is an XPS Document (YES in step S1314), then the XPS Document is sent to the IFC 124 at step S1316. Then the process returns to step S1310. If there is no XPS Document part in step S1314, the process returns to step S1318.

In step S1318, it is determined whether there is a Fixed Document Sequence (FDS) 140 or not. If yes, then the FDS 140 is processed at step S1320 where the function F2-F1 is performed. (see FIG. 5C; F2-P1 will be described later). Then, the process returns to step S1310. If it is not a FDS 140, the process proceeds to step S1322.

In step S1322, it is determined whether there is a Fixed Document (FD) 150 or not. If yes, then the FD 150 is processed at step S1324 where the function F2-P2 is performed (see FIG. 13D; F2-P2 will be described later). Then, the process returns to step S1310. If it is determined that there is not a FD 150, then the process proceeds to step S1326.

In step S1326, it is determined whether there is a Fixed Page 160 or not. If yes, the FP 160 is processed at step S1328 (see FIG. 5E; F2-P3 will be described later). Then, the process proceeds to step S1310. Or, if it is determined that there is no FP 160 in step S1326, then the process proceeds directly to step S1310.

If in step S1310, there are no parts available from the XPS Document Provider and a request shutdown has been called, it is determined in step S1311 by the DLF 410 whether the Page Cache is empty or whether a request shutdown has been called. If at step S1311 the Page Cache is found to not be empty, the cached pages are processed in function F2-P4 (step S1329) called by the DLF 410 (see FIG. 5F; F2-P4 will be discussed later on in the specification). Then the process ends.

Therefore, in review, when a part is available, its type is determined, and if it is an XPS Document as in step S1314, the XPS Document is sent to the next filter through IFC 124. In step S1318, if it is determined that the part is a Fixed Document Sequence 140 part, the DLF 410 sends the Fixed Document Sequence 140 to the JLF 420 through the IFC 124. If the part is determined to be a Fixed Document 150 in step S1322, the DLF 410 calls the F2-P2 function as described in FIG. 5B. Or, if it is a Fixed Page 160, the DLF 410 calls the F2-P3 function as described in FIG. 5E. Each part is processed until no more parts are available from the Microsoft XPS Document provider interface or request shutdown is called (NO in step S1310).

The following paragraphs will now herein described the functions F2-P1, F2-P2, F2-P3 and F2-P4). In FIG. 5C, the function F2-P1 is illustrated. In particular, at step S1330, the FDS 140 is sent to the IFC 124.

In FIG. 5D, the function F2-P2 is illustrated. At step S1340, it is determined whether cached pages for the previous document exists. If yes in step S1340, then all the cached pages are processed first in step S1342 wherein the F2-P4 is called from the DLF 410 requesting to process all the cached pages. Next, the process proceeds to step S1344. Also, if there are no cached pages in step S1340, then the process proceeds directly to step S1344.

In step S1344, the DLF 410 resets the Document Level Command List(DLCL) 450, and gets the Document Level Command List(DLCL) 450 for the Fixed Document 150. Then in step S1346, the Fixed Document 150 is sent to the Job Level & Physical Page Filter 420 through IFC 124.

Now referring back to step S1326 in FIG. 5B, in the DLF 410, if the document part is a Fixed Page 160 part, then function F2-P3 is called which is illustrated in FIG. 5E. Now referring to FIG. 5E, in step S1350, it is determined whether the Document Level Command List (DLCL) 450 is empty or not. In particular, the DLF 410 checks the DLCL 450 to determine whether it is empty. If not (NO in step S1350), then in step S1354, the page is added to the Page Cache. Next, in step S1356, the cached pages are processed by calling function F2-P4 as illustrated in FIG. 5F (to be discussed later) and then the process ends. Otherwise, if in step S1350, the DLCL 450 is found to be empty, then the Fixed Page 160 is sent to the JL&PPF 420 via the IFC 124.

FIG. 5F illustrates the function F2-P4 called up from step S1329 (see FIG. B). Instep S1360, it is determined whether all the commands in the DLCL 450 have been performed or not. If there are commands in the DLCL 450, each command is executed on the pages in the Page Cache (step S1362). Then the process proceeds to step S1363. Also, in step S1360, if all the commands in the DLCL 450 are executed, the process proceeds to step S1363. If the function F2-P2 is requested to process all the pages in the Page Cache from DLF 410 and the Page Cache is not empty (YES in step S1363), then steps S1360-S1362 will be performed until the page cache is empty.

Further, in step S1364, while executing a command, the Command itself checks for the post-condition. If the post condition is met in step S1364, the processed page is then sent to the JL&PPF 420 through IFC 124 at step S1366.

### [Exemplary Initialization and Operation of Job Level & Physical Page Filter]

FIGS. 6A-G illustrate an exemplary flow for the initialization and start operation of the Job Level & Physical Page Filter (JL&PPF), according to an aspect of the present invention.

FIG. 6A illustrates the steps performed when the JLF 420 is requested to be initialized. At this time, the JLF 420 gets the Command Manager (CM) 430 interface from the Property Bag in step S1400. Then in step S1401, the CM interface 430 is stored for future use.

FIG. 6B describes exemplary processing of the XPS Document in the start operation of JL&PPF 420. In step S1410, it is determined whether any parts are available. In particular, in step S1410, each part is processed until no more parts are available from Microsoft XPS Document provider interface and a request shutdown is called.

When a part is available (YES in step S1410), its type is determined in steps S1412 through S1430. In step S1412, the JL&PPF 420 gets the XPS part from Ixps Document Provider. Next, it is determined whether the XPS part type is determined is an XPS Document part (step S1414). If yes, then the XPS Document is sent out through the IFC 124 (step S1416). Then the flow returns to step S1410.

In step S1414, if it is determined that the part type is not an XPS Document part, then it is next determined whether the part is a Fixed Document Sequence (FDS) 140 (step S1418). If yes, the F3-P1 function (see FIG. 6C; described later in the specification) is called to process the FDS 140 part (see step S1420). Then the flow returns to step S1410.

Otherwise, if in step S1418, it is determined that the part type is not a FDS 140, then, in step S1422, it is determined whether the part is a FixedDocument (FD) 150. If yes, the F3-P2 function (see FIG. 6D; described later in the specification) is called to process the FD 150 (step S1424). Then the flow returns to step S1410.

If in step S1422, it is determined that the part type is not a FD 150, then in step S1426, it is determined whether the part is a Fixed Page (FP) 160. If in step S1422 the part is a FP 160, the F3-P3 function (see FIG. 6E; described later in specification) is called to process the FP 160 (step S1428). Then, the process proceeds to returns step S1410. Also, if it is determined that there is no Fixed Page 160, then the process returns directly to step S1410.

Referring to step S1410, if no parts are available from the Ixps Document Provider and a request is called, then in step S1430, the JL&PPF 420 again checks the Page Cache to determine whether it is empty. If yes in step S1430, the process ends. Otherwise, if no in step S1430, the JL&PPF calls function F3-P4 in step S1432 (see FIG. 6F; described later in specification) to process all the cached pages. Then the process ends.

FIG. 6C describes the function F3-P1 called up from step S1420 (see FIG. 6B) from the JL&PPF 420. In step S1434, the JL&PPF 420 gets the JLCL 460 and PPCL 470 from the Command Manager 430. Then, the Fixed Document Sequence 140 is sent to next filter (if present in the filter pipeline) or printer 110 through the IFC 124 (step S1436).

FIG. 6D describes the function F3-P2 called up from step S1424 (see FIG. 6B) from the JL&PPF 420. If an incoming part is a FD 150, as determined in step S1422, the JL&PPF 420 simply sends out the FD 150 to the next filter (if present in the filter pipeline) or printer 110 through IFC 124 (step S1442).

FIG. 6E describes the function F3-P3 called up from step S1428 (see FIG. 6B) from the JL&PPF 420. In step S1450, it is determined whether or not the JLCL 460 is empty. If not, then the Fixed Page 160 is added to the Page Cache (step 1454). Then the cached pages are processed in step S1456 which calls up function F3-P4 (see FIG. 6F; described later in specification). On the other hand, if in step S1450 the JLCL 460 is empty, then the function F3-P5 (see FIG. 6G; described later in specification) is called for processing physical page commands in the PPCL 470 on the cached pages.

FIG. 6F describes the function F3-P4 called up from step S1432 (see FIG. 6B). In particular, FIG. 6F shows the functional aspect of processing cached pages using commands in the JLCL 460. In step S1460, it is determined whether all the commands in the JLCL 460 have been performed or not. If there are commands in the JLCL 460, then each command is executed by the JL&PPF 420 on the pages in the Page Cache (step S1462). Then the process proceeds to step S1463. Also, if in step S1460, if there are no commands in the JLCL 460, the process proceeds to step S1463. If the function F3-P4 is requested to process all the pages in the page cache and the page cache is not empty (YES in step S1463), then steps S1460-S1463 will be performed until the Page Cache is empty.

Further, in step S1464, while executing a command, Command itself checks for the post-condition. For example, after successful execution, and after merging two pages successfully, the merged pages are sent to further processing for physical page commands. In most of the cases, post-condition can be true of false. A false post-condition means the resulting page will be inserted back into the Page Cache itself. A true post-condition means that after successful completion, the resulting page will be further processed. If the post condition is met in step S1464, the processed page is then further processed by calling the function F3-P5 (see FIG. 6F; described next) which executes commands in the PPCL 470 on FP 160.

FIG. 6G describes the function F3-P5 called up from step S1466 (see FIG. 6F). In particular, FIG. 6G illustrates the functional aspect of processing FP 160 using commands in PPCL 470. In step S1470, if it is determined that there are commands in the PPCL 460 (YES in step S1470), then each commandis executed in step S1474 on the subjected FP 160. When all the commands are executed or when there are no more commands (NO in step S1470), the FP 160 will be sent to the next filter (if present in the filter pipeline) or the printer 110 through IFC 124.

### [Exemplary Timing Diagram]

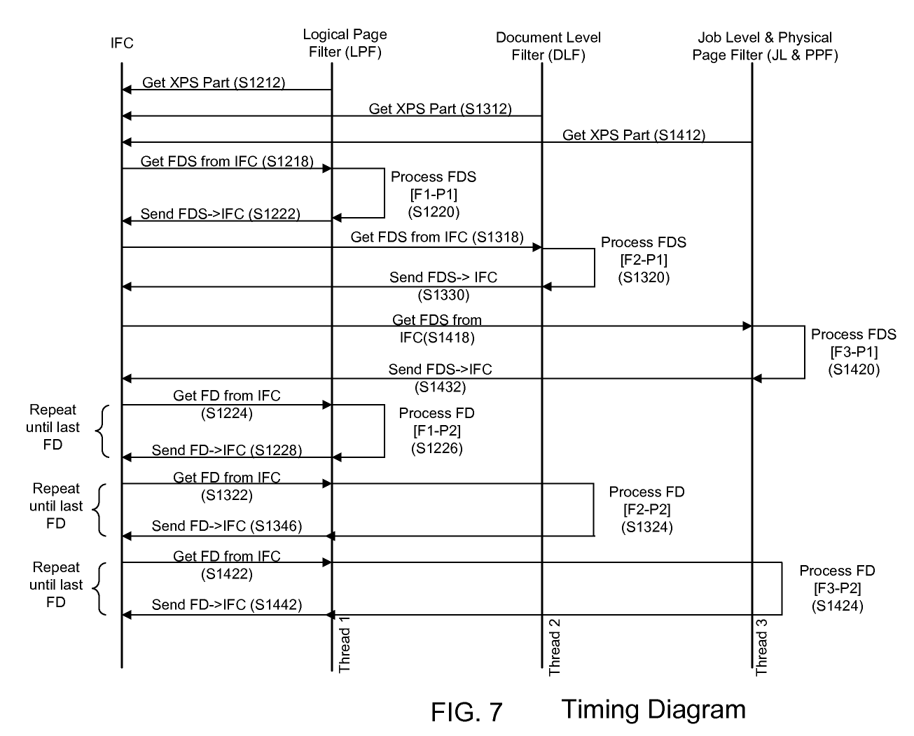

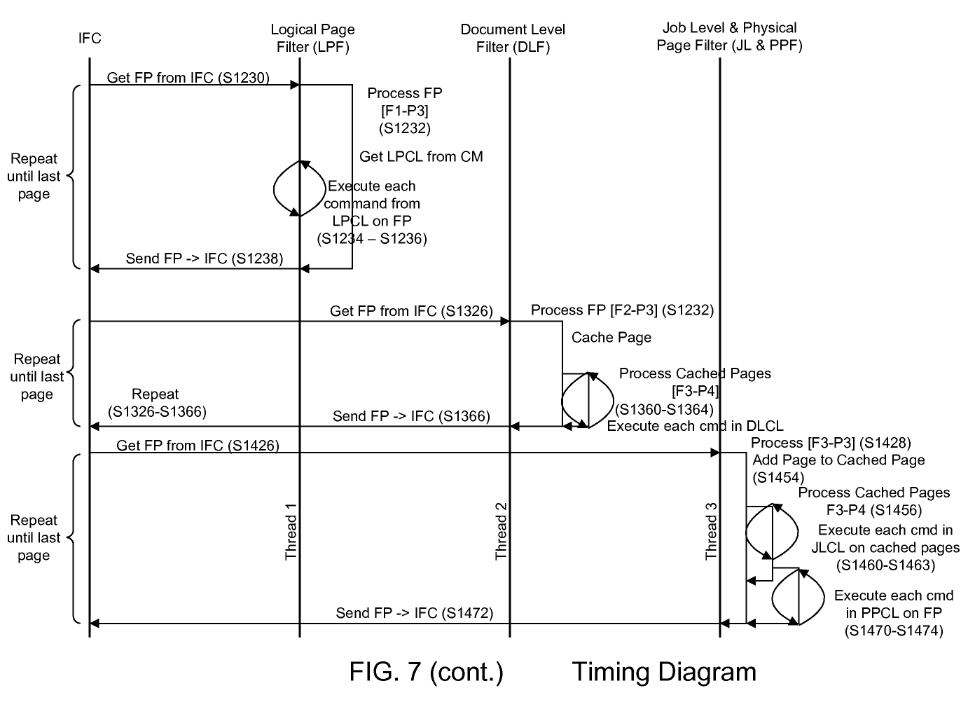

FIG. 7 illustrates an exemplary timing diagram of the overall functionality of the Logical Page Filter(LPF) 400, Document Level Filter(DLF) 410, and Job Level & Physical Page Filter(JL&PPF) 420 according to an aspect of the present invention. In particular, the timing diagram is provided to illustrate the interaction between the IFC 124, CM 430, LPF 400, DLF 410, and JL&PPF 420 with regard to events corresponding to the execution of Threads 1-3 which process the incoming XPS Document.

### Other Exemplary Embodiments

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

The embodiments described above current describes using Microsoft's Ixps Document Provider and Ixps Document Consumer as input and output interfaces respectively. However, Microsoft also provides IPrintReadStream and IPrintWriteStream as input and output interfaces for the filters. Nevertheless, the present invention also applies for the usage IPrintReadStream and IPrintWriteStream without any change to the core flow described above.

The functions described above can be implemented by a host computer according to a program installed from outside. In that case, the present invention is applicable to a case where information including programs is supplied from a storage media, such as a CD-ROM, a flash memory, and an FD, or from an external storage medium through the network.

A storage medium storing program code of software that executes the functions of the above-described embodiments can be supplied to a system or an apparatus. Then, an aspect of the present invention can be achieved by reading and executing the program code stored on the storage medium by a computer (alternatively, a CPU or an MPU) of the system or apparatus.

In this case, the program code itself read from the storage medium can achieve the functions of the above-described embodiments, and the storage medium storing the program code configures the present invention. Accordingly, any form of program can be used as long as it has a program function, such as object code, a program executed by an interpreter, and script data supplied to an OS.

The storage medium for supplying a program includes, for instance, a flexible disk, a hard disk, an optical disk, a magnet-optical disk, an MO, a CD-ROM, a CD-R, a CD-W, a magnetic tape, a nonvolatile memory card, a ROM, and a DVD.

Besides, as a method of supplying the program, a browser of a client computer can be used to connect to a web page on the Internet. A computer program according to the present invention can be supplied from the web page. Alternatively, the computer program can be supplied from a compressed file including an automatic installation function downloaded into a storage medium such as a hard disk.

Moreover, program code that constitutes a program according to the present invention can be divided into a plurality of files, and each file can be downloaded from different web pages. In other words, a WWW Server or an FTP server allowing a plurality of users to download the program file for achieving the functional processes of the embodiments in a computer is included in the scope of the present invention.

Moreover, the program according to the present invention can be encrypted and stored on a storage medium such as a CD-ROM to be distributed to users. Then, a user who meets a predetermined condition is allowed to download key information for decryption from a web page via the Internet. The user can install and execute the encrypted program using the key information.

Moreover, with program code read and executed by a computer, not only the functions of the embodiments are achieved but also an OS operating on the computer can perform all of or part of the actual processing based on the instruction of the program code. The functions of the embodiments are achieved by the processes described above.

In addition to that, program code read from a storage medium is written to a memory provided in a function extension board inserted in a computer or a function extension unit connected to a computer. Then, a CPU provided in the function extension board or the function extension unit performs all of or part of the actual processing based on the instruction of the program code. The functions of the embodiments are achieved by the above-described processes.

It is further noted that with regard to the LPF 400, DLF 410 and the JL&PPF 420, the order of checking the XPS part type can be changed, and is not necessarily limited to the order illustrated in FIGS. 4B, 5B and 6B. For example, in FIG. 4B, step S1230 may be performed before step S1214; or step S124 may be preformed after step S1230, for example.

What is claimed:

1. A filter pipeline framework for a printer driver including a plurality of filters, the filter pipeline framework comprising:
a logical page filter configured to perform operations on logical pages within a first thread;
a document level filter configured to perform document level operations within a second thread;
a job level and physical page filter configured perform job level operations and physical page operations within a third thread; and
a command managing unit configured to generate and manage commands compiled in command lists for the filters,
wherein print ticket processing is performed at the beginning of the filter pipeline in the logical page filter,
wherein each filter simultaneously runs within its own thread to perform a specific scope of operations defined for each filter.

2. The filter pipeline framework according to claim 1, wherein command lists are generated by the command manager via a request from the logical page filter.

3. The filter pipeline framework according to claim 1, wherein command lists include,
a logical page command list for commands to be performed on individual logical pages;
a document level command list for commands to be performed on fixed pages of an individual document;
a job level command list for commands to be performed on a complete job; and
a physical page command list for commands to be performed on individual physical pages.

4. The filter pipeline framework according to claim 1, wherein whole document processing is divided based on the specific scope of operations for each filter.

5. The filter pipeline framework according to claim 1, wherein operations performed in each filter may be dynamically configured based on user intent specified in print ticket settings.

6. The filter pipeline framework according to claim 1, wherein the logical page filter, document level filter and job level and physical page filter are not assigned based solely on printing features.

7. The filter pipeline framework according to claim 1, wherein the logical page filter, document level filter and job level and physical page filter may be arranged such that operations on least dependent parts are performed first such that a next filter in the pipeline can start processing parts of a document without delay.

8. The filter pipeline framework according to claim 1, further including,
a pre-condition command for triggering whether an operation on the command may be executed or not; and
a post-condition command for triggering performing an additional task after performing a command.

9. The filter pipeline framework according to claim 1, wherein the printer driver is an XPSDrv print driver including an XPSDrv filter pipeline utilized within a Microsoft® Windows® operating system.

10. The filter pipeline framework according to claim 9, wherein the Microsoft® Windows® operating system is one of Windows Vista™, Windows XP and Windows Server™ 2003.

11. A method for controlling a filter pipeline for a printer driver including a logical page filter, document level filter, job level and physical page filter, and command manager, the method comprising:
processing print tickets in the logical page filter;
then simultaneously,
performing operations in the logical page filter on logical pages within a first thread;
performing document level operations in the document level filter within a second thread;
performing job level operations and physical page operations in the job level and physical page filter within a third thread; and
generating and managing commands compiled in command lists for the filters,
wherein each filter runs within its own thread to perform a specific scope of operations defined for each filter.

12. The method according to claim 11, further comprising generating command lists by the command manager via a request from the logical page filter.

13. The method according to claim 11, wherein command lists include,
a logical page command list for commands to be performed on individual logical pages;
a document level command list for commands to be performed on fixed pages of an individual document;
a job level command list for commands to be performed on a complete job; and
a physical page command list for commands to be performed on individual physical pages.

14. The method according to claim 11, further comprising dividing whole document processing based on the specific scope of operations for each filter.

15. The method according to claim 11, further comprising dynamically configuring the operations performed in each filter based on user intent specified in print ticket settings.

16. The method according to claim 11, wherein the logical page filter, document level filter and job level and physical page filter are not assigned based solely on printing features.

17. The method according to claim 11, further comprising arranging the logical page filter, document level filter and job level and physical page filter such that operations on least dependent parts are performed first such that a next filter in the pipeline can start processing parts of a document without delay.

18. The method according to claim 1, further comprising:
triggering whether an operation on a command may be executed or not via a pre-condition command; and
triggering performing an additional task after performing a command via a post-condition command.

19. The method according to claim 1, wherein the printer driver is an XPSDrv print driver including an XPSDrv filter pipeline utilized within a Microsoft® Windows® operating system.

20. The method according to claim 19, wherein the Microsoft® Windows® operating system is one of Windows Vista™, Windows XP and Windows Server™ 2003.

21. A computer readable medium containing computer-executable instructions for controlling a filter pipeline for a printer driver including a logical page filter, document level filter, job level and physical page filter, and command manager, the medium comprising:
computer-executable instructions for processing print tickets in the logical page filter,
computer-executable instructions for then simultaneously,
performing operations in the logical page filter on logical pages within a first thread;
performing document level operations in the document level filter within a second thread;
performing job level operations and physical page operations in the job level and physical page filter within a third thread; and
computer-executable instructions for generating and managing commands compiled in command lists for the filters,
wherein each filter runs within its own thread to perform a specific scope of operations defined for each filter.

22. The medium according to claim 21, further comprising computer-executable instructions for generating command lists by the command manager via a request from the logical page filter.

23. The medium according to claim 21, wherein command lists include,
a logical page command list for commands to be performed on individual logical pages;
a document level command list for commands to be performed on fixed pages of an individual document;
a job level command list for commands to be performed on a complete job; and
a physical page command list for commands to be performed on individual physical pages.

24. The medium according to claim 21, further comprising computer-executable instructions for dividing whole document processing based on the specific scope of operations for each filter.

25. The medium according to claim 21, further comprising computer-executable instructions for dynamically configuring the operations performed in each filter based on user intent specified in print ticket settings.

26. The medium according to claim 21, wherein the logical page filter, document level filter and job level and physical page filter are not assigned based solely on printing features.

27. The medium according to claim 21, further comprising computer-executable instructions for arranging the logical page filter, document level filter and job level and physical page filter such that operations on least dependent parts are performed first such that a next filter in the pipeline can start processing parts of a document without delay.

28. The medium according to claim 21, further comprising:
computer-executable instructions for triggering whether an operation on a command may be executed or not via a pre-condition command; and
computer-executable instructions for triggering performing an additional task after performing a command via a post-condition command.

29. The medium according to claim 21, wherein the printer driver is an XPSDrv print driver including an XPSDrv filter pipeline utilized within a Microsoft® Windows® operating system.

30. The medium according to claim 29, wherein the Microsoft® Windows® operating system is one of Windows Vista™, Windows XP and Windows Server™ 2003.
